(19) United States
(12) Patent Application Publication
(10) Pub. No.: US 2002/0118454 A1
(43) Pub. Date: Aug. 29, 2002

(54) System for stereoscopic viewing of an image

(76) Inventor: John Hey, Weston, MA (US)

Correspondence Address: BRIAN M. DINGMAN, MIRICK, O'CONNELL, DEMALLIE & LOUGEE, LLP, 100 FRONT STREET, WORCESTER, MA, 01608, US

(21) Appl. No.: 09/682,659

(22) Filed: Oct. 3, 2001

Related U.S. Application Data
(60) Provisional application No. 60/240,254, filed on Oct. 13, 2000.
(60) Provisional application No. 60/241,777, filed on Oct. 19, 2000.

(51) Int. Cl. G02B 27/22

(52) U.S. Cl. 359/466; 359/462

(57) ABSTRACT

A system for stereoscopic viewing of an image, comprising displaying upon a generally flat surface a conventional stereoscopic pair of images, with the images proximate but separate from one another. The system includes an optical device adapted to be placed in front of a viewer's eyes, in which the optical axis for at least one eye is re-angled, so that each eye generally targets the center of a respective one of the pair of images.

### CROSS REFERENCE TO RELATED APPLICATIONS

This application claims benefit of Provisional applications entitled “Devices and Methods for Stereoscopic Viewing”, Ser. No. 60/240,254, filed on Oct. 13, 2000, and “Devices and Methods for Stereoscopic Viewing”, Ser. No. 60/241,777, filed on Oct. 19, 2000.

### FIELD OF THE INVENTION

The present invention relates to techniques for displaying and viewing stereoscopic images, and more particularly, to techniques for displaying and viewing conventional stereoscopic image pairs presented upon commonly available surfaces and media. More particularly, the present invention relates to the design and use of an associated viewing apparatus for viewing such images. Still more particularly, the present invention relates to systems and methods for maximizing, where possible, the viewer's sense of immersion into the viewed image.

### BACKGROUND OF INVENTION

To simulate ordinary binocular stereoscopic vision, the basic task is to present to each of the viewer's eyes a 2-dimensional image depicting the respective left- or right-eyed view of the desired scene. When the two images sufficiently closely match each other, the brain's binocular vision melds the two images into a single 3-dimensional one.

For consumer-level applications, it is desirable to present the pair of 2D images using conventional graphic media, such as a printed page, or TV, video-, or movie-screens. For conventional media to deliver to the eyes such a pair of images, a method is needed for viewing two proximate images, one with each eye. (Only proximate non-overlapping images are considered here, because only such “ordinarily” rendered images typically exploit fully a medium's graphic capabilities, which is an object of the present invention.)

To facilitate the viewing of such a pair of proximate images, existing methods have used binocular mirror-systems to displace each eye's optical axis so that it centers perpendicularly upon its respective image. It is usual to arrange such a pair of images side-by-side, but also possible instead to place one image above the other. As the left-right symmetry inherent in stereoscopic vision would suggest, existing methods and viewing-devices typically treat both eyes identically (albeit reciprocally).

### SUMMARY OF INVENTION

Taking the above into consideration, an object of the present invention is the low-cost, convenient presentation and viewing of high-quality stereoscopic images using a wide variety of commonly available graphic media.

The present invention provides a new approach to displaying and viewing a pair of conventional stereoscopic images on ordinary media. As with previous methods, the images are placed proximate to each other.

In one illustrative embodiment, the images are placed one above the other. Both eyes gaze nominally at the bottom image, but one of the eyes actually looks into a mirror apparatus that deflects that eye's gaze upward to view the top image instead. Note that, rather than being fully “displaced” upward so as to effectively view the top image perpendicularly (i.e., head-on), the gaze is instead primarily “re-angled” (i.e., turned) to aim somewhat upward, and thus doesn't remain exactly perpendicular to the image-surface.

Naturally, the upward -gazing eye's respective image therefore appears as somewhat distorted. Because it is being viewed from “below”, that image appears to be disproportionately larger at the bottom. And, especially because the apparatus's mirrors further lengthen that images eye-to-image optical path, the image appears smaller overall to its respective eye. The resulting mismatch with the other eye's normally-viewed image interferes with the stereoscopic melding of the two images. The present invention prescribes two remedies for such disparities: (1) If the overall eye-to-image distance is made sufficiently large, then the mismatch becomes negligible, because the viewer's brain ignores it and melds the two images adequately; (2) The image can be rendered as already “reverse-distorted”, to compensate for any distorting perspective. Thereby, any given portion of the image is made to “coincide” with its corresponding portion in the other, normally viewed, image. (This works because each eye, considered separately, perceives primarily 2-dimensionally, largely ignoring any intra-image depth variance.)

Note that viewing the image from any off-center perspective (and not merely from below-center) incurs similar distortions, which in turn are subject to similar remedies.

Meanwhile, one advantage of the present invention is already apparent: Only one of the viewer's eyes needs to be optically manipulated by the viewing-device whose design may thus be correspondingly smaller (e.g., by half).

The above and other objects, features, and advantages of the present invention will become apparent from the following description, taken in conjunction with the accompanying drawings which illustrate preferred embodiments of the present invention by way of example.

### BRIEF DESCRIPTION OF DRAWINGS

FIGS. 1A, 1B, and 1C illustrate a horizontally arranged stereoscopic image-pair, and contrast viewing-devices of the prior art and of the present invention.

FIGS. 2A, 2B, and 2C illustrate a vertically arranged stereoscopic image-pair, and contrast viewing-devices of the prior art and of the present invention.

FIGS. 3A, 3B, 3C, and 3D demonstrate an advantage in flexibility of the present invention over the prior art.

FIG. 4 depicts an embodiment wherein the viewer's gaze is nominally toward the more distant image.

FIGS. 5A, 5B, and 5C illustrate the visual distortion known as “keystoning”.

FIGS. 6A, 6B, 6C, and 6D exemplify how an image may be “reverse-distorted” to compensate for distortion caused by an elevated viewing perspective.

FIGS. 7A and 7B (and 7C) show side-views of an example (two-)mirror viewing-device and an example prism viewing-device.

FIG. 8 shows how a two-eyed viewing-device deflects each eye's optical path for a vertically arranged image-pair.

FIGS. 9A, 9B, 9C, and 9D exemplify how an image may be “reverse-distorted” to compensate for close-perspective distortion (a.k.a. “barrel-distortion”).

FIGS. 10A, 10B, and 10C illustrate a (“poster”-sized) embodiment wherein one image is “reverse-distorted”.

FIGS. 11A, 11B, and 11C illustrate an embodiment wherein both images are “reverse-distorted”.

FIGS. 12A-12G illustrate an embodiment wherein “reverse-distorting” counteracts distortion inherent in the display surface.

### DETAILED DESCRIPTION

Certain preferred embodiments of the present invention will now be described in conjunction with the accompanying drawings.

This description refers to the display of a “conventional stereoscopic pair of images”. Such an image pair is two normally oriented pictures of a single subject, representing the perspective of a hypothetical viewer's left- and right-eye, respectively. (The prior art displays the two images usually side-by-side, but sometimes instead one above the other.)

The description also refers to a “generally flat surface” (upon which the image pair is displayed). Such media are those typically used for the display of 2-dimensional images, i.e., TV, movies, video-game, computer screen, electronic display, printed page, drawing, painting, mural, etc. (Note that specific media may be mentioned as examples when presenting embodiments. Notwithstanding, the present invention applies to all such media and surfaces.)

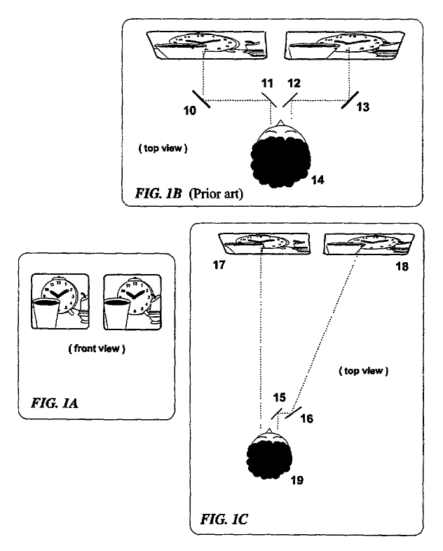

In the first preferred embodiment, a conventional stereoscopic image-pair is displayed on an ordinary graphic surface (such as a printed page), with the images being placed proximate and side-by-side, as in FIG. 1A. Using prior art, the image-pair is typically viewed as exemplified in FIG. 1B, wherein the viewer 14, positioned level with and between the two images, employs a viewing-device whose mirrors (10 thru 13) fully displace sideways each eye's optical axis, so that it targets perpendicularly the center of its respective image. By contrast, the present invention is exemplified in FIG. 1C, wherein the viewer 19, whose left eye is centered before the left image 17, employs a viewing-device whose mirrors (15 and 16) re-angle the right eye's optical axis to target the center of the right image 18, albeit not exactly perpendicularly. (The larger the viewer-to-image distance, the more nearly perpendicular is the re-angled eye's view.)

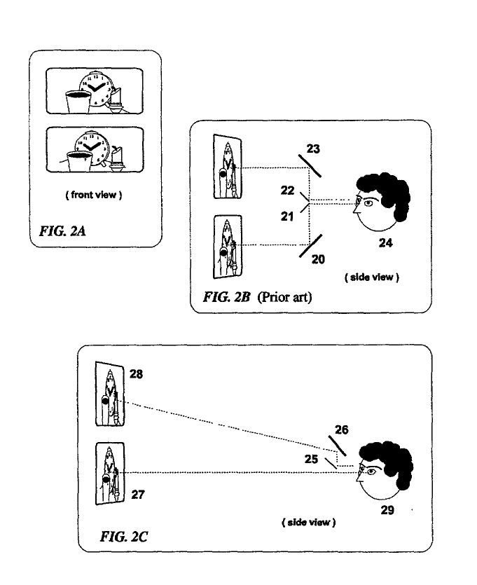

In a variation of the first preferred embodiment, the image-pair is displayed with one eye's image being placed proximate and above the other eye's image, as in FIG. 2A. Using prior art, the image-pair is typically viewed as exemplified in FIG. 2B, wherein the viewer 24, positioned level with and between the two images (i.e., centered upon the boundary separating them), employs a viewing-device whose mirrors (20 thru 23) raise/lower each eye's optical axis, so that it targets perpendicularly the center of its respective image. By contrast, the present invention is exemplified in FIG. 2C, wherein the viewer 29, whose left eye is centered before the bottom image 27, employs a viewing-device whose mirrors (25 and 26) re-angle the right eye's optical axis to target the center of the top image 28 (again not exactly perpendicularly). Obviously, either eye's optical axis can be re-angled, and the non-re-angled eye can gaze at either image, with the appropriately designed and used viewing device of this invention.

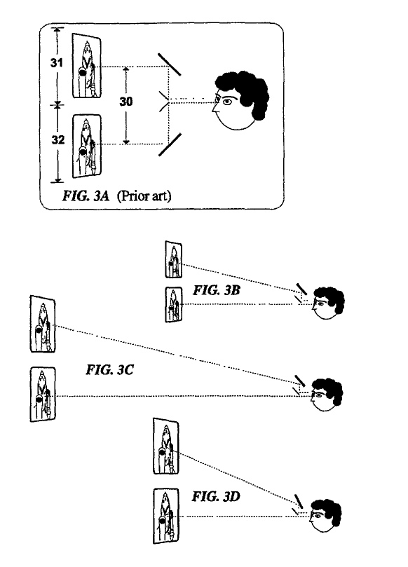

An advantage of the present invention is exemplified in FIG. 3: Using the prior art shown in FIG. 3A, each image must be no larger (in the interocular direction 31) than the interocular distance 30 effected by the viewing-device. However, using the present invention (shown in FIG. 3B), larger images may simply be viewed from farther away (as in FIG. 3C) or, alternatively, a mirror of the viewing-device may be rotated to increase the degree of re-angling (as in FIG. 3D). This flexibility becomes especially noteworthy when, for example, an image-pair is broadcast onto variously sized TVs, or is offset-printed larger (e.g., for higher resolution, or for many simultaneous viewers).

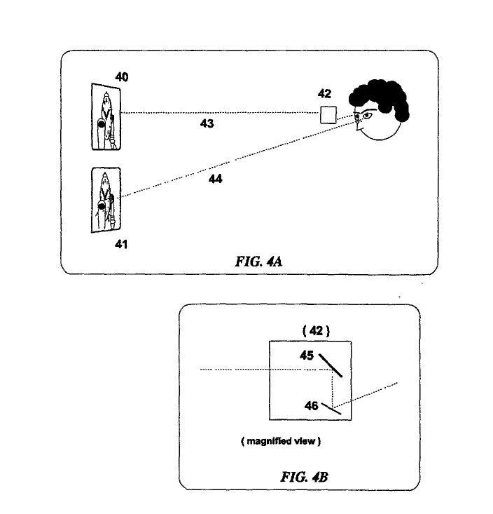

An illustrative variation of the first preferred embodiment is shown in FIG. 4A. Here, the viewer's eyes now are level with the top image 40. However, both eyes gaze downward toward the bottom image 41. Meanwhile, a viewing-device 42 re-angles upward one eye's optical axis 43 so that it targets the center of the top image 40. Such a viewing configuration may allow the two images' optical paths to be more nearly equal in length. This is because the top image's optical path 43, ostensibly shorter than the bottom image's 44, may actually include a hidden “detour” within the viewing-device itself. (As exemplified in FIG. 4B, mirrors 45 and 46 could cause such a detour.)

A second preferred embodiment is now described, wherein a deliberate reshaping (e.g., “reverse-distorting”) of the bottom image is applied.

The preceding embodiments work well when the eye-to-image distance is relatively large. But when the eye-to-image distance is not so large, certain apparent distortions of an image can be worsened. (As an extreme example, the view of a 1-foot-square image from 10 feet away is relatively undisturbed by, say, shifting the head a few inches off-center. But the view of the same image from only 1 foot away is quite distorted to begin with, and becomes much worse if the head is thus shifted.)

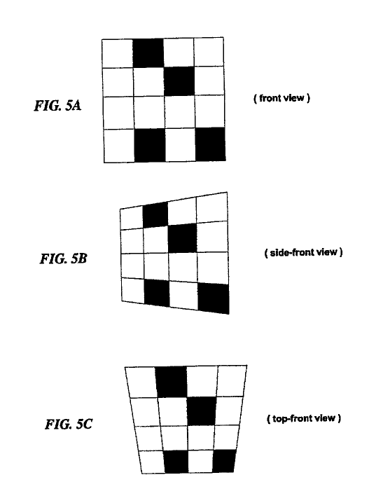

A common such distortion is illustrated in FIG. 5. An image that's rectangular when viewed from head-on (FIG. 5A), seems to become trapezoidal when viewed from the side of center (FIG. 5B) or from above center (FIG. 5C). This sort of distortion is called “keystoning”.

Another simple distortion occurs whenever one eye's optical path is longer than the other eye's (as in, for example, FIGS. 1C and 2C.) Then, the more “distant” image naturally appears smaller than the other.

To compensate for such distortions, the second preferred embodiment deliberately and proportionately reshapes (i.e., reverse-distorts) one image prior to rendering. This reshaping effectively moves each point of the original image to its corresponding-when-viewed point in the reshaped-and-rendered image. (One example method of effecting such a reshaping is to project the initial image onto a tilted surface. Another example method is to simulate such a projection by manipulating the pixels of a computer-graphics file of the image.)

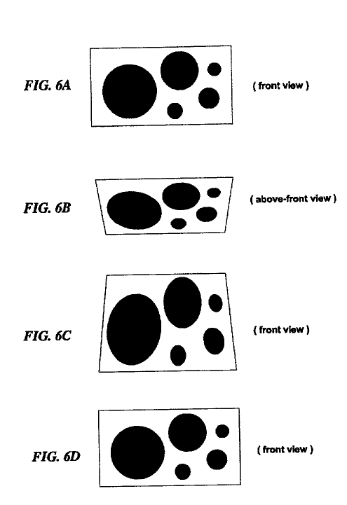

When the appropriately reshaped image is viewed from the anticipated distorting perspective, the image seems to transform back into its original normal aspect. This effect is illustrated in FIG. 6. The image we wish the viewer (to seem) to see is a simple rectangle FIG. 6A. But when such an image is viewed from above head-on, it appears as a trapezoid FIG. 6B. This particular distortion is called “keystoning”. So, to counteract the anticipated keystoning, we first “reverse-distort” the image to resemble the reciprocally keystoned trapezoid FIG. 6C, and we display that reverse-distorted image instead. When the reverse-distorted image FIG. 6C is viewed from above head-on, it appears to the viewer as the original simple rectangle FIG. 6D (and 6A).

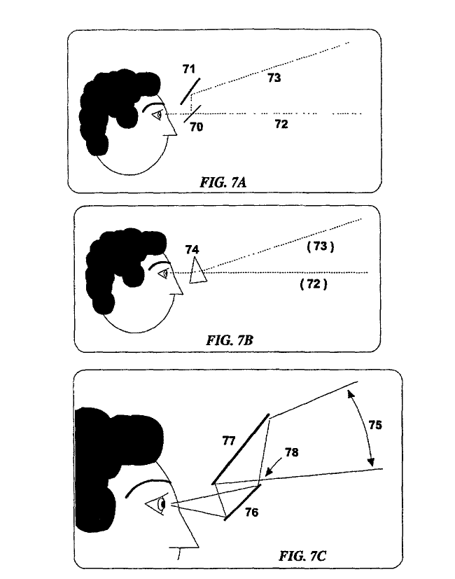

Using an upward-deflection configuration as an example (e.g., FIG. 2C), two preferred embodiments of the viewing-device are diagrammed in FIGS. 7A and 7B.

The device shown in FIG. 7A comprises two proximate flat mirrors 70 and 71, each tilted about a horizontal axis that parallels the image-plane. Mirror-surface 70 is tilted to 45-degrees. Mirror-surface 71 is tilted to slightly vertical of 45-degrees. Because the device “obstructs” only the right-eye, the left-eye's optical path 72 proceeds unimpeded. Meanwhile, because of the slightly mismatched mirror-angles, the right-eye's optical path 73 is deflected upward at a desired angle. (It is also slightly raised, i.e., displaced, as though the right-eye were higher than the left.)

(FIG. 7C illustrates a further characteristic of this embodiment of a two-mirror device: The embodiment intends merely to re-angle the optical axis, but to lengthen it only minimally. Therefore, the vertical distance between mirrors 76 and 77 is just large enough to allow clearance for mirror 77's field-of-view 75, i.e., at point 78. This also helps minimize size of the device required for a given field of view.)

Rather than using mirrors to deflect the optical path upward, the device shown in FIG. 7B uses a simple prism 74 instead. Similar to FIG. 7A, the prism “obstructs” only the right-eye, deflecting its optical path upward at a desired angle.

Other embodiments of the viewing device may employ additional optics, such as focus-aiding lenses, and more complex prism optics (e.g., compound serial or Fresnel-type prisms).

A further embodiment of the viewing-device features mirrors whose positions and/or angles may be adjusted by the viewer, so that a single device may be used to view a variety of differently arranged and sized image-pairs, and to view them from various distances and angles.

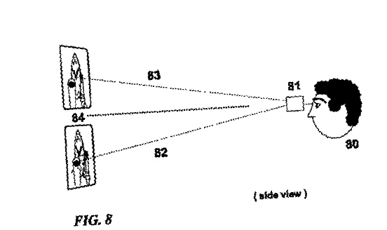

In yet a further embodiment of both the viewing-device and the display of image-pairs, each of the viewer's eyes has a corresponding mirror-pair within the viewing-device. Thus, for a vertically arranged image-pair, as in FIG. 8, the viewer 80, now gazes nominally at the center of both images (i.e., at a point 84 between them), through a viewing-device 81 that “obstructs” each eye with its own mirror-pair (or prism). Thus, one eye's optical path 83 is re-angled upward to the top image, and the other eye's optical path 82 is re-angled downward to the bottom image. Note that the use of two mirror-pairs does gain some advantages (e.g., from treating the two eyes symmetrically), but deflecting both eyes' gazes tends to disorient the viewer.

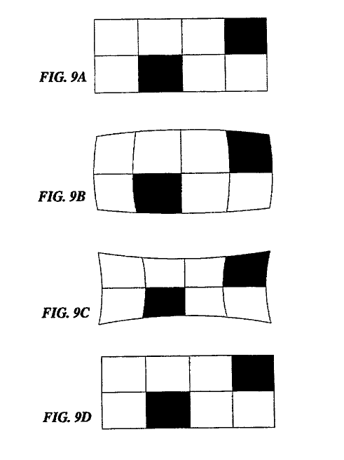

The “reverse-distorting” of images can be used to compensate not only for “keystoning” as described above, but for other distortions as well. For example, even when the eye gazes head-on into the center of a rectangular image, some distortion occurs because the rectangle's corners are farther than its center from the viewing eye. This is particularly acute when the eye is close to the image. (Such an effect is called “barrel distortion”). To illustrate, the image we wish the viewer (to seem) to see is a simple rectangle FIG. 9A. But when such an image is viewed from very close, it appears as a “barrel” FIG.9B (i.e., with bulging sides). So, to counteract the anticipated distortion, we first “reverse-distort” the image to resemble a “pincushion” FIG. 9C, and we display that reverse-distorted image instead. When the reverse-distorted image is viewed from very close, it appears to the viewer as the original simple rectangle FIG. 9D (and 9A).

Still other distortions may be counteracted in this manner, including distortions inherent in the original image (e.g., the barrel-distortion caused by some camera lenses), distortions introduced by the viewing-device itself (e.g., the tendency of simple prisms to curve straight lines), and distortions inherent in the rendering medium (e.g., the convex screen of many TVs).

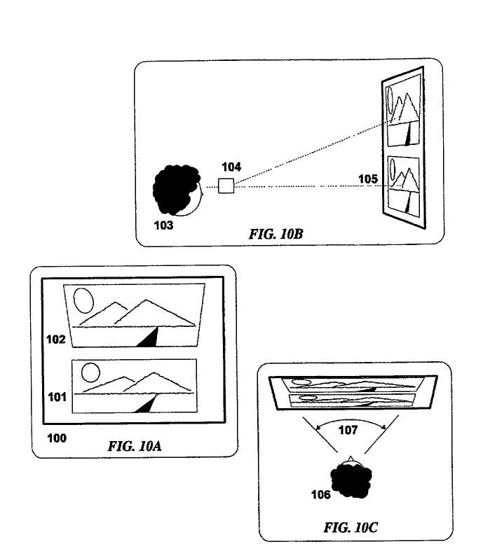

Note that the “reverse-distorting” technique employs an aspect of the present invention that can be stated and applied more generally: Because each of the two images is viewed with a single eye (i.e., 2-dimensionally), an image can be considered to comprise its respective eye's field-of-view, where each “pixel” of the field corresponds to a pixel on the physical display-surface, with relatively little regard for either the distance to the display-pixel or the distance to its stereoscopically viewed “actual” pixel. Thus it can be said that the present invention employs a conveniently flat display-surface to “paint” separately upon the virtual sphere that surrounds each eye. And, “reverse-distorting” (i.e., prior to display) is a matter of maneuvering an image's pixels so that, upon display, each pixel will appear in its proper position on the virtual sphere. (The concept of discrete pixels is used merely metaphorically, and is not essential to the present invention.). FIGS. 10A, 10B, and 10C show an embodiment that exploits certain advantages of the present invention. The display-surface is a large, “poster”-sized print 100, on which appear a left-eye image 101 and a “reverse-distorted” right-eye image 102. The large size of the displayed images allows the viewer 103, (using the viewing-device 104) to view the (normal) left-eye image 105 from quite close (like sitting in the front row at the movies). Because of the resulting wide view-angle 107, the viewer 106 enjoys a substantially immersive stereoscopic experience. Furthermore, the large display-surface of this embodiment facilitates the presentation of very-high-resolution images, which enhances the viewer's sense of recreated reality.

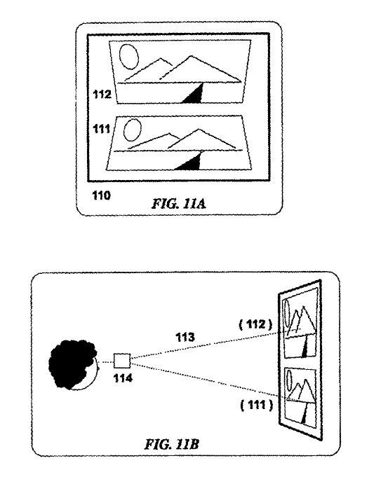

FIGS. 11A and 11B show a similar embodiment. Here, the viewer's position is level with the boundary between the two images 111 and 112 (rather than centered on one of them as in FIG. 10B). Accordingly, the viewer's gaze 113 is nominally upward toward the top image (as the viewing-device 114 again turns one eye's gaze downward to the bottom image). To present their respective rectangular aspects to this embodiment's viewer position, both images are “reverse-distorted”, as shown.

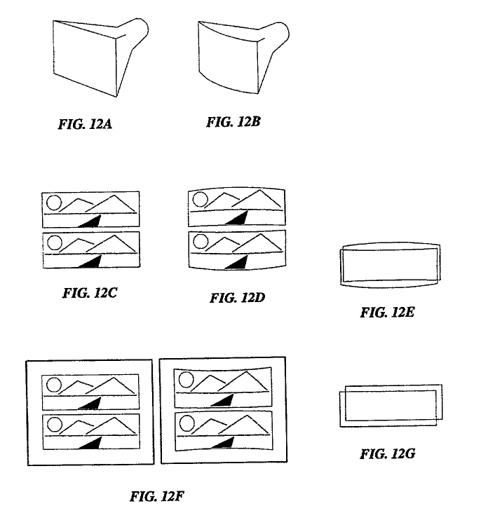

A further embodiment exemplifies how “pre-distorting” an image may compensate for distortion inherent in a display surface. Rather than being perfectly flat (FIG. 12A), many TVs and other CRT display surfaces are convex (FIG. 12B). Therefore, a vertically arranged image-pair (FIG. 12C) displayed normally may appear to “bow” outward (especially at top and bottom in the example shown in FIG. 12D). The resulting mismatch may be great enough to thwart a stereoscopic meld (FIG. 12E). By “reverse-distorting” the images (as shown in FIG. 12F) to counteract the anticipated distortion, the images appear to have a more “normal” (and matching) aspect when viewed, as in FIG. 12G.

1. A system for stereoscopic viewing of an image, comprising:
means for displaying upon a generally flat surface a conventional stereoscopic pair of images, proximate but separately from one another; and
an optical device adapted to be placed in front of a viewer's eyes, and comprising means for re-angling the optical axis for at least one eye, so that each eye generally targets the center of a respective one of the pair of images.

2. The system of claim 1, in which the images are arranged one above the other.

3. The system of claim 1, in which the optical axis for exactly one eye is re-angled.

4. The system of claim 3, in which the images are arranged one above the other.

5. The system of claim 1, in which at least one image is deliberately distorted prior to display, to counteract distortion caused by the viewer's position.

6. The system of claim 1, in which at least one image is deliberately distorted prior to display, to counteract distortion caused by the viewing-device.

7. The system of claim 1, in which at least one image is deliberately distorted prior to display, to counteract distortion inherent in the display surface.

8. The system of claim 1, wherein said images comprise the display for a video-game.

9. The system of claim 1, wherein said images comprise a televised display of still-or motion-picture images.

10. The system of claim 1, wherein said images comprise a computer-graphics display of still- or motion-picture images.

11. The system of claim 1, wherein said optical device comprises a pair of mirrors for each re-angled eye.

12. The system of claim 11, wherein the angle of at least one of the optical device's mirrors is adjustable, to accommodate variation in image positioning or viewing distance.

13. The system of claim 1, wherein said optical device comprises a prism for each re-angled eye.

14. A system for stereoscopic viewing of an image, comprising:
means for displaying upon a generally flat surface a conventional stereoscopic pair of images, proximate but separately from one another; and
means for improving the stereoscopic match between the two images as viewed, by distorting at least one of the images; and
an optical device adapted to be placed in front of a viewer's eyes, and comprising means for re-angling the optical axis for at least one eye, so that each eye generally targets the center of a respective one of the pair of images.

15. The system of claim 14, in which the images are arranged one above the other.

16. The system of claim 14, in which the optical axis for exactly one eye is reangled.

17. The system of claim 16, in which the images are arranged one above the other.

18. The system of claim 14, in which at least one image is deliberately distorted prior to display, to counteract distortion caused by the viewer's position.

19. The system of claim 14, in which at least one image is deliberately distorted prior to display, to counteract distortion caused by the viewing-device.

20. The system of claim 14, in which at least one image is deliberately distorted prior to display, to counteract distortion inherent in the display surface.

21. The system of claim 14, wherein said images are displayed upon a surface large enough to subtend an immersive portion of the viewer's visual field.

22. The system of claim 14, wherein said images comprise the display for a video-game.

23. The system of claim 14, wherein said images comprise a televised display of still- or motion-picture images.

24. The system of claim 14, wherein said images comprise a computer-graphics display of still- or motion-picture images.

25. The system of claim 14, wherein said optical device comprises a pair of mirrors for each re-angled eye.

26. The system of claim 14, wherein said optical device comprises a prism for each re-angled eye.

27. An optical device, used binocularly, for re-angling the optical axis for at least one eye, causing the eyes' axes to diverge substantially from each other, while otherwise generally retaining their matching orientations.

28. The device of claim 27, in which the optical axis for each re-angled eye is re-angled either upward or downward.

29. The device of claim 27, in which the optical axis for exactly one eye is reangled.

30. The device of claim 27, comprising a pair of mirrors for each re-angled eye.

31. The device of claim 30, where the angle of at least one mirror is adjustable, to accommodate variation in image positioning or viewing distance.

32. The device of claim 27, comprising a prism for each re-angled eye.

33. The device of claim 27, employed to effect a stereoscopic meld of two 2-dimensional images.

34. The device of claim 27, not affixed to a viewed target or target-holder.

35. The device of claim 34, worn by the viewer, or held by the viewer as though worn.

36. An optical device for re-angling the optical axis for at least one eye, comprising:
a pair of mirrors for each re-angled eye, where the pair's mirrors are separated approximately enough to accommodate a desired degree of deflection and field-of-view.

37. The device of claim 36, comprising a pair of mirrors for exactly one eye.

38. The device of claim 36, where the angle of at least one mirror is adjustable, to accommodate variation in image positioning or viewing distance.

39. An image display structure, displayed upon a generally flat surface, for use with an optical device which re-angles at least one eye so that each eye targets its respective image, comprising:
a conventional stereoscopic pair of images, the images proximate but separate from one another.

40. The structure of claim 39, wherein the images are arranged one above the other.

41. An image display structure for displaying upon a generally flat surface. comprising:
a conventional stereoscopic pair of images, the images proximate but separate from one another, wherein at least one image is deliberately distorted prior to display, to counteract distortion caused by the viewer's position.

42. An image display structure for displaying upon a generally flat surface, comprising:
a conventional stereoscopic pair of images, the images proximate but separate from one another, wherein at least one image is deliberately distorted prior to display, to counteract distortion caused by a viewing-device.

43. An image display structure for displaying upon a generally flat surface, comprising:
a conventional stereoscopic pair of images, the images proximate but separate from one another, wherein at least one image is deliberately distorted prior to display, to counteract distortion inherent in the display surface.
